(19) United States
(12) Patent Application Publication
(10) Pub. No.: US 2009/0266753 A1
(43) Pub. Date: Oct. 29, 2009

(54) Dispensing System for Microbial Solution

(76) Inventors: David Johnson, Boerne, TX (US); Reginald Salinas, Helotes, TX (US); George Pearson, Mountville, PA (US)

Correspondence Address: JACKSON WALKER, L.L.P., 112 E. PECAN, SUITE 2400, SAN ANTONIO, TX, 78205, US

(21) Appl. No.: 12/393,807

(22) Filed: Feb. 26, 2009

Related U.S. Application Data
(60) Provisional application No. 61/067,153, filed on Feb. 26, 2008.

(51) Int. Cl. B01D 21/30; B67D 5/06; F16L 55/07

(52) U.S. Cl. 210/138; 222/646; 222/180; 137/320; 137/318

(57) ABSTRACT

A system and method for dispensing microbial solution into a drain line. The system includes a disposable cartridge adapted to hold a quantity of microbial solution. The cartridge may be provided to the end user containing only a dry mix of microbes in a carrier medium. The end user may then remove a replaceable tab covering a fill hole, fill the cartridge with clean water, and replace the tab. The cartridge may then be inserted into a dispensing assembly, which includes an actuator that engages a nozzle on the cartridge at regular intervals. When the actuator engages the nozzle, a small amount of microbial solution is dispensed and routed through a tube to the drain line. The tube may attach to the drain line through a self-tapping valve assembly.

The patent application claims priority to U.S. Provisional Patent Application No. 61/067,153, filed Feb. 26, 2008, which is incorporated herein by reference.

### BACKGROUND

This specification relates to the field of plumbing maintenance and more particularly to an improved system for dispensing microbial solutions.

Microbial solutions can be useful in keeping drain lines clean and functional. Generally, the bacteria are selected to consume the food, oil and grease (“FOG”) that can build up in drain lines. FOG may be particularly detrimental in some food service establishments. FOG-consuming microbial solutions are most effective when dispensed at regular or semi-regular intervals over a long time. For example, in some prior art devices, a quantity of solution sufficient for use over one month is mixed in a five-gallon bucket and connected to a drain line. An effective amount of solution is dispensed from the bucket into the drain line by a timed pump, which dispenses solution into the drain line one time per day.

### BRIEF DESCRIPTION OF THE DRAWINGS

FIG. 1 is a cover-opened perspective view of a dispensing system for microbial solution.

FIG. 2 is a front view of a wall unit of the dispensing system for a microbial solution.

FIG. 3 is a cover-closed front view of the dispensing system for a microbial solution.

FIG. 4 is a back view of the dispensing system for a microbial solution.

FIG. 5 is a detailed front view of a cartridge for use in the dispensing system for a microbial solution.

FIG. 5A is a top view of a cartridge for use in the dispensing system for a microbial solution.

FIG. 6 is a top view of a wrench for use in installing the dispensing system for a microbial solution.

FIG. 7 is a view of a long nylon tube used in the dispensing system for a microbial solution.

FIG. 8 is a perspective view of a self tapping valve assembly of the dispensing system for a microbial solution.

FIG. 9 is a view of sub-assemblies of a self tapping valve assembly the dispensing system for a microbial solution.

FIG. 10 is a side view of sub-assemblies of a self tapping valve assembly more particularly showing the tapper and bit, of the dispensing system for a microbial solution.

FIG. 11 is a side view of a self tapping valve assembly, affixed to a drain pipe, of the dispensing system for a microbial solution.

FIG. 12 is a front cut-away view of a self tapping valve assembly, affixed to a drain pipe, of the dispensing system for a microbial solution.

FIG. 13 is a block diagram showing interconnections of the electromechanical portions of the dispensing system of the of the dispensing system for a microbial solution.

### DETAILED DESCRIPTION OF THE EMBODIMENTS

A system and method for dispensing microbial solution into a drain line is disclosed.

The system includes a disposable cartridge adapted to hold a quantity of microbial solution. The cartridge may be provided to the end user containing only a dry mix of microbes in a carrier medium. The end user may then remove a replaceable tab covering a fill hole, fill the cartridge with clean water, and replace the tab. The cartridge may then be inserted into a dispensing assembly, which includes an actuator that engages a nozzle on the cartridge at regular intervals. When the actuator engages the nozzle, a small amount of microbial solution is dispensed and routed through a tube to the drain line. The tube may attach to the drain line through a self-tapping valve assembly.

The microbial solution dispensing system disclosed in this specification provides for dispersion of concentrated microbial solution to a drain line over an extended period of time. In one embodiment, this is accomplished by providing a disposable cartridge, which may hold approximately 10 fluid ounces, or 296 mL of liquid. The cartridge is provided with a dry microbial solution consisting of approximately 99% inert carrier medium and 1% microbes. A user may remove the tab, fill the cartridge with approximately 10 mL of water, and replace the tab, which helps seal the cartridge. The user may then insert the cartridge into the wall unit, which may be hung on a wall. Once the cartridge is locked in a wall unit and power is applied and an actuator engages a nozzle in the cartridge. The actuator may actuate the nozzle at regular intervals, for example, every fifteen minutes. When the actuator actuates the nozzle, a small amount of microbial solution is injected into a conduit. This amount may be approximately 0.1 mL. The microbial solution is carried into the conduit and through a tube until it is injected into a drain line, which may receive undesirable quantities of FOG. The microbes then safely break down the FOG to ease its movement into the plumbing system.

A dispensing system for microbial solution will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, widget 102-1 may refer to a “pen,” which may be an instance or example of the class of “writing implements.” Writing implements may be referred to collectively as “writing implements 102” and any one may be referred to generically as a “writing implement 102.”

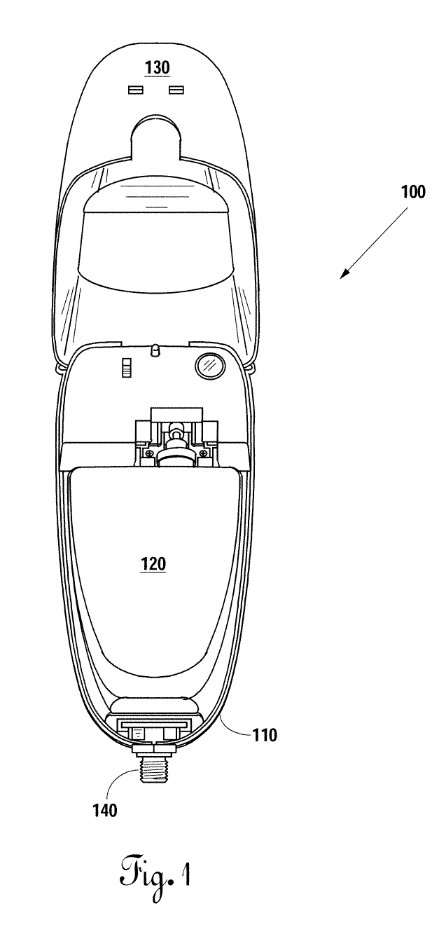

FIG. 1 generally discloses a dispensing system for microbial solution 100. The dispensing system 100 includes a cartridge 120 seated securely in a wall unit 110 which has a hinged cover 130 [shown in a raised position]. As one skilled in the art will appreciate, the cartridge 120, the wall unit 110, and the hinged cover 130 may be fabricated from any material capable of being molded or shaped, including, e.g., plastic, aluminum, stainless steel, etc.

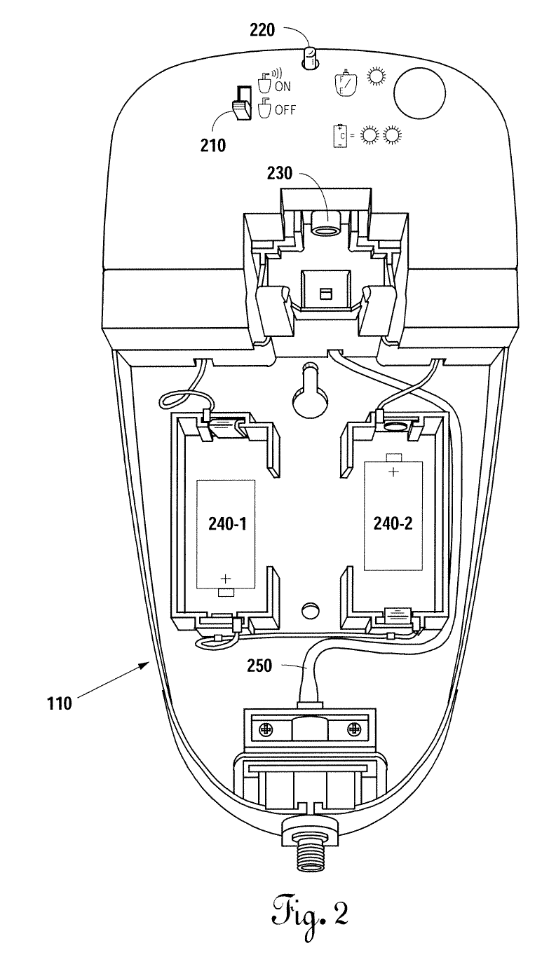

Turing to the wall unit 110, FIG. 2 depicts a more detailed view thereof, with cartridge 120 (FIG. 1) removed. As shown, the wall unit 110 includes electronics subassembly 205 and a dispensing subassembly 215. Electronics subassembly 205 powers the automated operation of the dispensing assembly to ensure that an appropriate about of microbial solution is dispensed from the wall unit 110 at a preset interval. Electronics subassembly 205 includes a power switch 210, and indicator light 220, a sensor (not shown), a timer (not shown), an actuator 230, battery holders 240, and batteries (not shown). The indicator light 220 and sensor are connected to appropriate electronics and indicates that the refill cartridge needs to be replaced or that the batteries need to be changed. As can be seen, batteries and battery holders 240 are provided to provide power to the unit when batteries are installed. The timer is connected to the batteries and controls the time when the microbial solution is dispensed. As one skilled in the art will appreciate, the timer allows the dispensing system 100 to operate independently, e.g., to dispense an appropriate amount of microbial solutions at pre-determined intervals.

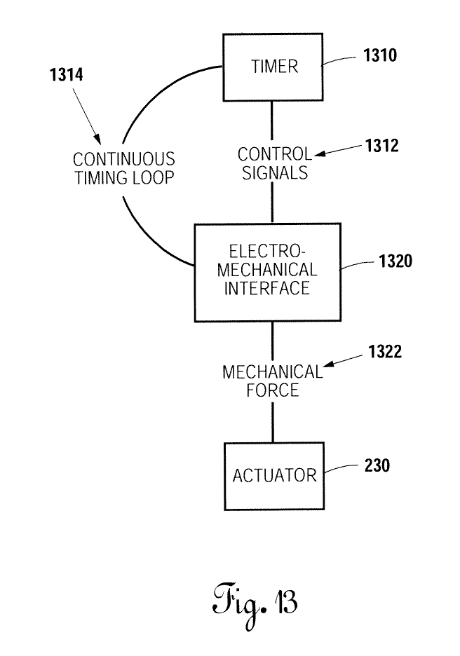

FIG. 13 shows how the timer is electro-mechanically connected to the dispensing sub assembly 215. Specifically, when timer 1310 determines that continuous timing loop 1314 has counted down a predetermined time, timer 1310 sends control signals 1312 to electro-mechanical interface 1320. Electro-mechanical interface 1320 converts control signals 1312 into a mechanical force 1322 which then operates dispensing sub assembly 215.

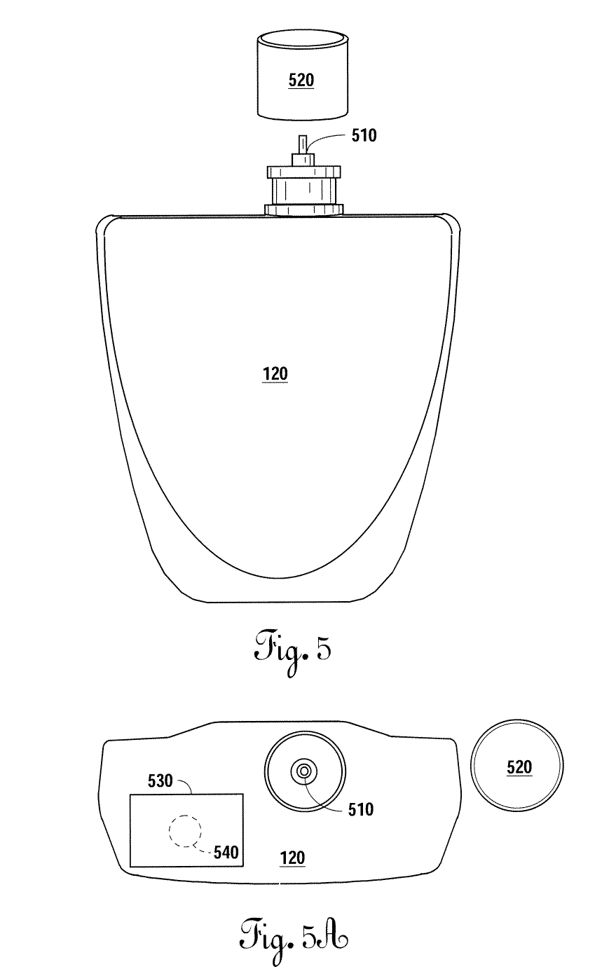

The dispensing subassembly 215 includes the actuator 230 and conduit 250. Actuator 230 is configured to engage the dispensing nozzle 510 (FIG. 5) of cartridge 120 (FIG. 1) and, is manipulated when the timer signals that the microbial solution should be dispensed into a conduit 250. The conduit 250 is configured from, e.g., plastic tubing, and provides a pathway for liquid to flow from the cartridge to a drain line after the actuator 230 is manipulated (FIG. 1).

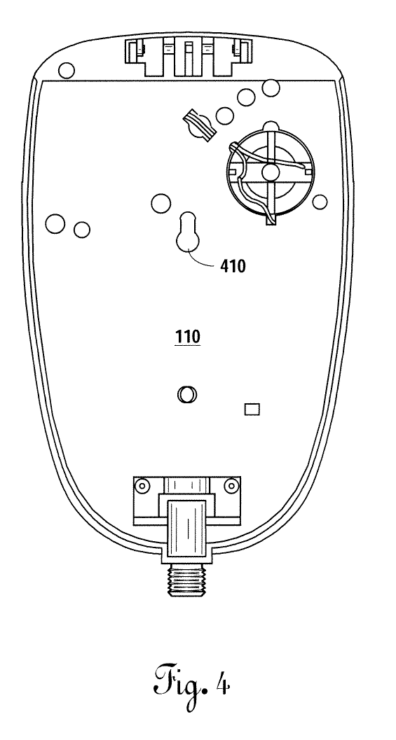

FIG. 4 depicts the back view of wall unit 110. As can be seen, the wall unit is provided a mounting hole 410, which may used to attach the wall unit 110 to a screw affixed to a wall. While the wall unit 110 may be connected to the wall via an adhesive, and such mounting capability is within the scope of this disclosure, mounting the wall unit 110 to a screw on the wall is preferable for use where there is abundant grease, hot steam and other grime, e.g., a commercial kitchen.

As one skilled in the art will appreciate the wall unit and all of the aforementioned components of the electronics subassembly and dispensing assembly are not novel or unique, and are of a type commonly manufactured by Waterbury Inc., to dispense fragrance into a toilet. This novel invention modifies the above device for the purpose disclosed herein.

FIG. 5 is a more detailed front view of a cartridge 120 adapted for use with the dispensing system 100. Such a cartridge may be of a sufficient volume to hold approximately 10 fluid ounces, or 296 mL of liquid. The cartridge 120 includes a dispensing nozzle 510, a storage cap 520 and adhesive tab (not shown). Dispensing nozzle 510 is configured to be mechanically actuated by actuator 230, i.e., when the nozzle is actuated, this may allow a volume of liquid to be dispensed from the cartridge. In some embodiments, a single actuation of the dispensing nozzle 510 will release approximately 0.1 mL of liquid. There is also shown a storage cap 520 which is configured to fit over the dispensing nozzle 510, and to protect the dispensing nozzle 510 during storage and shipment of the cartridge 120. FIG. 5A, which is a partial plan view of a cartridge 120, shows the dispensing nozzle 510 and the storage cap 520 more clearly while offering a view of adhesive tab 530. The adhesive tab 530 is provided to protect the contents of the cartridge 120, and covers a pre-drilled hole 540. The adhesive tab may be plastic, aluminum, paper or the like, coated with any commercial adhesive.

Pre-drilled hole 540 allows an end-user to re-fill the cartridge 120 with water or other liquid, and is size accordingly, e.g., ⅜″. In some embodiments, the cartridge 120 will be provided with only a dry microbial mixture. In that case, when the end-user is ready to use cartridge 120, the end-user may peel back adhesive tab 530 and fill the cartridge with clean water through pre-drilled hole 540. After the end-user completes the filling, the end-user may then re-apply the adhesive tab 530 to again seal the cartridge 120. Alternatively, the end-user may apply a new adhesive tab. Furthermore, any device configured to re-sealably block pre-drilled hole 540 may be substituted for adhesive tab 530.

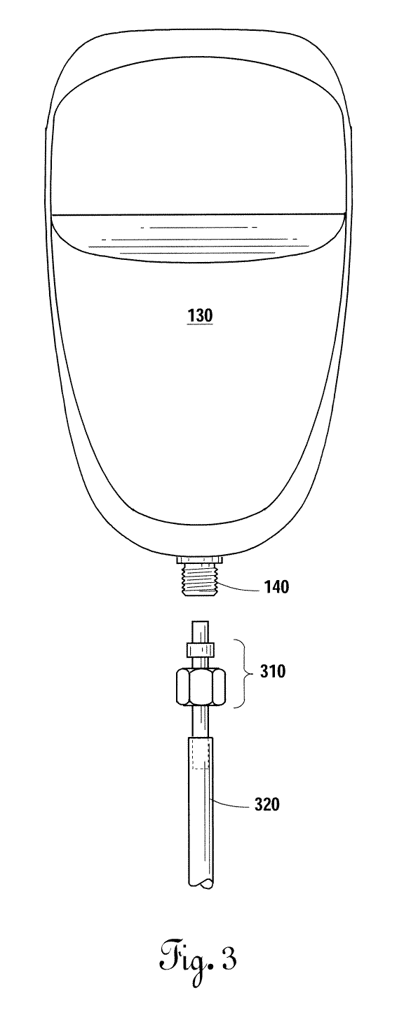

The assembly for connecting the wall unit 110 to the drain pipe will not be described with reference to FIGS. 3 and 7-12.

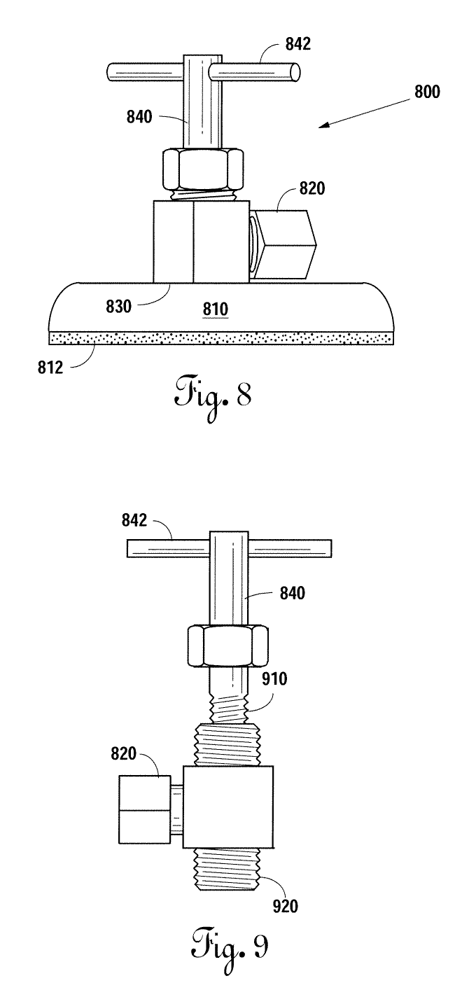

FIG. 3 depicts a front view of the wall unit 110 with the hinged cover 130 in a closed position, and shows the assembly for connecting the wall unit 110 to the drain line. The assembly for connecting the wall unit 110 to the drain line includes a threaded connector 140, coupling assembly 310, short tube 320, long tube 700 (FIG. 7), valve couple and self tapping valve assembly (FIG. 8). All of these elements are located at the base of the wall unit 110. A threaded connector 140 is provided to connect the conduit to a short tube 320 via a coupling assembly 310. The short tube 320 which may be relatively stiff to help to prevent kinking at this interface, in turn provides a conduit between the wall unit and the drain line or a long tube (FIG. 7). The long tube 700, shown in FIG. 7, is provided to connect the end of the short tube to the drain line in situations where the short tube will not reach. The long tube 700 may be connected to the short tube 320 via adhesive, screw means, friction fit, or the like. Moreover, Long tube 700 may have an outer diameter of ¼ inch to allow it to interface via friction fit to the short tube 320, which may have an inner diameter of ¼ inch. As one skilled in the art will appreciate, the short tube, long tube and conduit can be fabricated, e.g., from nylon, plastic and the like.

As shown in FIG. 7, at one end of long tube 700 (or the short tube 320) there may be provided a valve couple 710. Valve couple 710 allows the long tube 700 to be interfaced to a self-tapping valve assembly 800, which may be in fluid communication with a drain pipe (FIG. 8). Self tapping valve assembly 800 includes a fluid source interface 820, a valve casing 830, and a pipe mount 810. As can be seen, the fluid source interface 820 allows the self tapping valve assembly 800 to interface with the valve couple 710 (FIG. 7). As shown, the fluid source interface may be provided with threads to threadably connect to the valve couple 710, but a connection via adhesive, friction fit, etc., is within the scope of this invention. In some embodiments, valve casing 830, and pipe mount 810 and fluid source interface 820 may even be formed substantially of a single piece of plastic or polyvinyl chloride. In such configurations, threads may not be necessary.

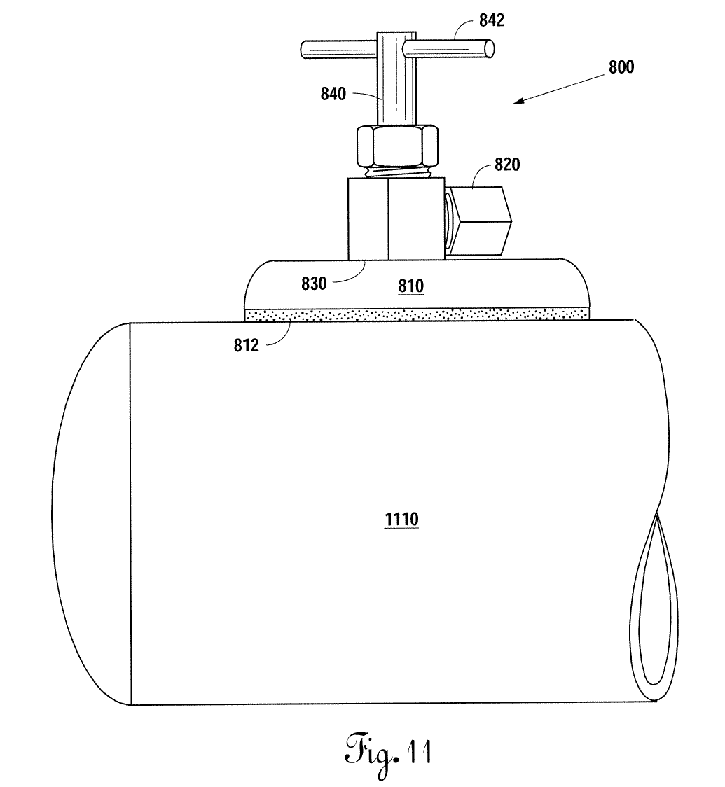

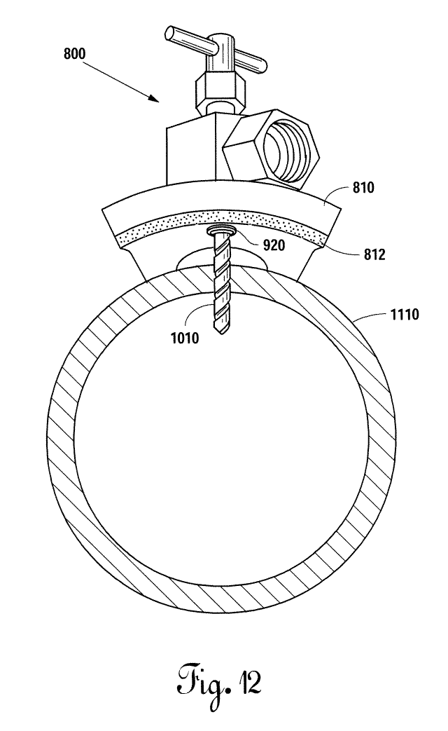

Returning to the self tapping valve assembly 800, valve casing 830, which includes a tapper 840 having a hand grip 842, interfaces between the self-tapping valve assembly 800 to the pipe mount 810. The tapper 840 threadably engages valve casing 830, and hand grips 842 are provided to allow a user to manually manipulate tapper 840. To connect the self tapping valve assembly 800 to the drain pipe, bit 1010 may be affixed to one end of tapper 840 (FIG. 10). Bit 1010 is a self piloting drill bit that bores into the drain pipe. FIG. 12 discloses a partial cut-away front view of bit 1010 interfacing with pipe 1110, wherein after bit 1010 has successfully bored a hole through pipe 1110, bit 1010 may be retracted from the pipe 1110. As one skilled in the art will appreciate, the pipe mount may also be attached to the drain pipe via, e.g., an adhesive layer 812, which affixes the self tapping valve assembly to the same (FIG. 11).

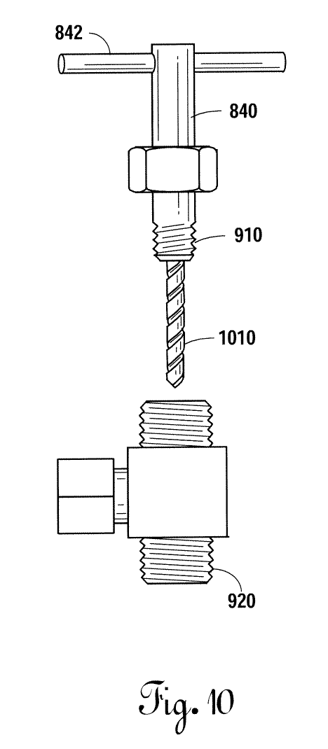

FIG. 9 depicts an embodiment of the self tapping valve assembly. Specifically, fluid source interface 820, tapper 840 and hand grip 842 are shown. A threaded shaft 910 is formed as part of tapper 840. Threaded shaft 910 allows tapper 840 to threadingly engage valve casing 830. Moreover, pipe mount interface threads 920 may be used to threadably engage the valve casing 830 to the pipe mount 810.

### Initial Installation

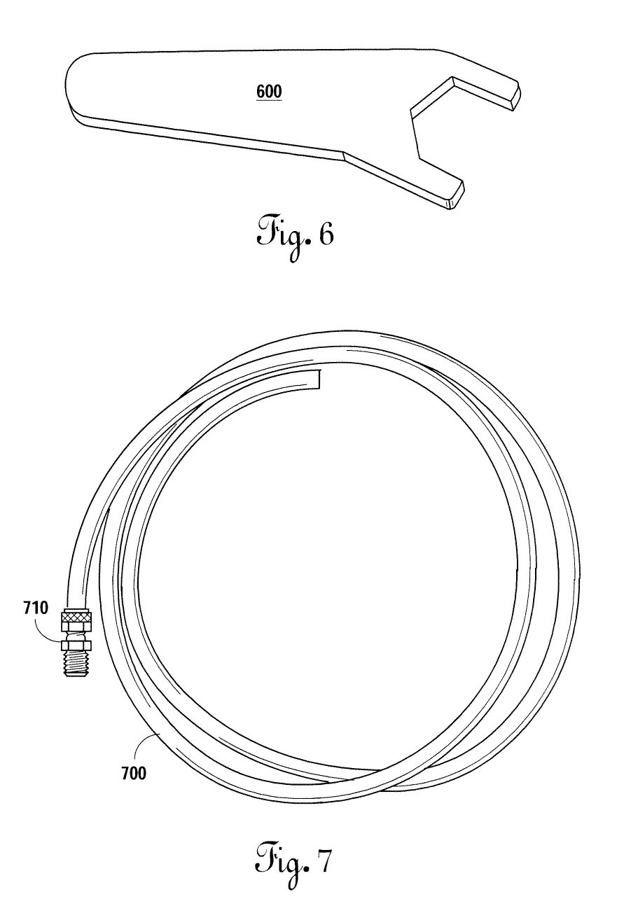

End users may be provided with a kit that includes all the materials necessary to install dispensing system 100. The kit may be provided with all of the items disclosed in FIGS. 1-12, with the exception of drain line pipe 1110. A user intending to install the dispensing system 100 may first find a suitable location, for example, on a wall. The user would then affix a screw into the wall. When the screw is firmly affixed into the wall, the user may then hang wall unit 110 on the wall with mounting hole 410. Either before or after mounting the wall unit 110 to the wall, the end-user may install short tube 320 into threaded connector 140 with coupling assembly 310. Wrench 600 may be useful in this installation step. The user may then insert one end of long tube 700 into one end of short tube 320. The other end of long tube 700 may be provided with valve couple 710. Valve couple 710 may allow the long tube 700 to be interfaced to self-tapping valve assembly 800. This interface may be accomplished through the fluid source interface 820 of the self-tapping valve assembly 800. Pipe mount 810 may be provided with an adhesive layer 812. The adhesive layer 812 may include a peel-off backing that is useful for protecting the adhesive until the pipe mount is ready to be used. In this case the user may peel off the backing of the adhesive layer 812 and affix pipe mount 810 to pipe 1110. Once the self-tapping valve assembly 800 is affixed to the pipe 1110, the user may manipulate hand grip 842, turning in a clock-wise direction. This drives the bit 1010 into pipe 1110, boring a hole into pipe 1110. The user may then manipulate the hand grip 842, turning in a counter clock-wise direction thus removing the bit 1010 from pipe 1110. This leaves a small hole in pipe 1110. Fluid is thus enabled to flow through long tube 710 into fluid source interface 820 through the valve casing 830 and into the hole made by bit 1010. In some embodiments, tapper 840 may be completely removed from the valve casing after the hole has been bored. In this case, a cap may be provided to seal the threaded socket that held tapper 840. In other embodiments, tapper 840 may be retracted after boring a hole, but not completely removed from the self tapping valve assembly 800.

With the system thus installed, the end user may simply replace the cartridge at regular intervals, for example, at one month intervals. While the unit is functional, a small amount of microbial solution will be injected into the pipe at regular intervals, for example, every fifteen minutes. This provides a steady stream of concentrated microbial solution into the pipe to process FOG.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A dispensing system for microbial solution, the dispensing system comprising:
a cartridge configured to hold a first volume of microbial solution, the cartridge including a dispensing nozzle, the dispensing nozzle configured to be mechanically actuated; and
a timed release assembly configured to hold the cartridge, the timed release assembly comprising:
an actuator in mechanical communication with the dispensing nozzle;
a conduit in fluid communication with the dispensing nozzle; and
a controller configured to actuate the actuator at timed intervals;
wherein the dispensing nozzle is configured to inject a second volume of the microbial solution into the conduit when actuated by the actuator, wherein the second volume is less than the first volume.

2. The system of claim 1 wherein the actuator forms a portion of the conduit.

3. The system of claim 1 wherein the cartridge further comprises a hole adapted to be covered by a replaceable tab, the hole adapted to allow the cartridge to be filled with a liquid.

4. The system of claim 3 wherein the hole has a diameter of approximately three-eighth inch.

5. The system of claim 1 wherein the first volume is approximately 10 fluid ounces of microbial solution.

6. The system of claim 1 wherein the second volume is approximately 0.1 milliliter.

7. The system of claim 1 wherein the timed intervals are approximately fifteen minutes and wherein the second volume is approximately one three-thousandth of the first volume.

8. The system of claim 1 wherein the cartridge is disposable.

9. The system of claim 1 further comprising:
a tube in fluid communication with the conduit and in fluid communication with a drain pipe;
wherein the conduit and tube together form a path for microbial solution injected into the conduit to flow into the drain pipe.

10. The system of claim 9 wherein the tube interfaces to the drain pipe through a self-tapping valve assembly.

11. A dispensing system for a liquid, the dispensing system comprising:
a cartridge configured to hold a first volume of liquid, the cartridge including a dispensing nozzle, the dispensing nozzle configured to be mechanically actuated; and
a timed release assembly configured to hold the cartridge, the timed release assembly comprising:
an actuator in mechanical communication with the dispensing nozzle;
a conduit in fluid communication with the dispensing nozzle; and
a controller configured to actuate the actuator at timed intervals; and
a self-tapping valve assembly in fluid communication with the conduit, the self-tapping valve assembly configured to interface the conduit to a pipe;
wherein the dispensing nozzle is configured to inject a second volume of the liquid into the conduit when actuated by the actuator, wherein the second volume is less than the first volume.

12. A self-tapping valve assembly comprising:
a valve casing;
a tapper threadably engaging to the valve casing, the tapper comprising:
a threaded shaft oriented along an axis substantially parallel to the axis of the valve casing; and
a bit affixed to one end of the threaded shaft;
a fluid source interface in fluid communication with the valve casing; and
a pipe mount configured to adhere to a pipe;
the self-tapping valve assembly operable to affix to the pipe, thereby allowing an operator to manipulate the tapper, causing the tapper to bore into the pipe, thereby allowing fluid communication between the fluid source interface and the pipe.

13. The device of claim 12 further comprising a hand grip adapted to permit the operator to manipulate the tapper by hand.

14. The device of claim 12 wherein the pipe mount adheres to the pipe by use of an adhesive layer.

15. The device of claim 12 wherein the pipe mount is a substantially single member with a curvature adapted to match the curvature of the pipe.

16. The device of claim 15 wherein the pipe mount is constructed of a material similar to the material of the pipe.

17. The device of claim 16 wherein the pipe mount is constructed of polyvinyl chloride.
